(19) United States
(12) Patent Application Publication
(10) Pub. No.: US 2014/0004529 A1
(43) Pub. Date: Jan. 2, 2014

(54) SENSING METHOD

(71) Applicant: NIHON DEMPA KOGYO CO., LTD., Tokyo (JP)

(72) Inventors: Wakako SHINOBU, Saitama (JP); Hiroyuki KUKITA, Saitama (JP); Shunichi WAKAMATSU, Saitama (JP)

(21) Appl. No.: 13/927,127

(22) Filed: Jun. 26, 2013

(30) Foreign Application Priority Data
Jun. 27, 2012 (JP) 2012-143615

(51) Int. Cl. G01N 27/22

(52) U.S. Cl. CPC G01N 27/221
USPC 435/7.1; 436/501

(57) ABSTRACT

A sensing method includes supplying the sample solution to the adsorbing layer; subsequently supplying a first liquid to the adsorbing layer, the first liquid including a first sensitizer to bind with the object; subsequently discharging the first liquid from the adsorbing layer; subsequently supplying a second liquid to the adsorbing layer, the second liquid including a second sensitizer, the second sensitizer reacting to the first sensitizer to generate an insoluble material; obtaining a first frequency signal corresponding to an oscillation frequency of the oscillator circuit, the oscillation frequency being obtained by oscillating the piezoelectric resonator after liquid is supplied to the adsorbing layer and before the second liquid is supplied to the adsorbing layer; and obtaining a second frequency signal corresponding to an oscillation frequency of an oscillator circuit, the oscillation frequency being obtained by oscillating the piezoelectric resonator after the second liquid is supplied to the adsorbing layer.

### CROSS REFERENCE TO RELATED APPLICATIONS

This application claims the priority benefit of Japan application serial no. 2012-143615, filed on Jun. 27, 2012. The entirety of the above-mentioned patent application is hereby incorporated by reference herein and made a part of this specification.

### TECHNICAL FIELD

This disclosure relates to a sensing method where an object is adsorbed to an adsorbing layer on an electrode disposed at a piezoelectric piece and the object is sensed based on a change in a unique vibration frequency of the piezoelectric piece.

### DESCRIPTION OF THE RELATED ART

As a device for sensing a trace substance in a solution or gas, there has been known a sensing device which uses QCM (Quarts Crystal Microbalance) with a crystal resonator. With this type of sensing device, a substance is adsorbed onto the crystal unit, which constitutes a crystal oscillator circuit, for example, by an antigen-antibody reaction. A change in the unique vibration frequency of the crystal resonator caused by the mass change at this time is used for a qualitative analysis and a quantitative analysis of the trace substance, and in view of this, the larger the sample mass, the larger the change in the amount of vibration frequency. This allows performing highly accurate analysis. However, nowadays, trace measurements of a substance on the order of pico, nano, or similar is desirable. A sensing device using a general antigen-antibody reaction cannot handle measurements where the change in the amount of vibration frequency is minute and highly accurate analysis cannot be performed in some cases.

Japanese Unexamined Patent Application Publication No. 2006-275865 discloses a technique where mass sensitizing is performed using mass sensitizing particles made of latex particles or gold colloid particles in determining a quantity using a QCM sensor. Further, the crosslinkable compound is reacted with the particles for sensitization by a crosslinkable reaction. In this method, a measuring object is interposed between an electrode and mass sensitizing particles “a” where a substrate “B” and a substrate “C” are secured. Next, mass sensitizing particles “b”, which contains a substrate “C”, and a crosslinkable compound “E”, which contains a substrate “D” reacting to the substrate “C”, are added. Accordingly, the type of agent is increased, and it is necessary to preliminary immobilize the respective substrates to a mass sensitizing particles “a” and “b”. It is difficult to simplify the task of amplifying the frequency change.

A need thus exists for a sensing method which is not susceptible to the drawback mentioned above.

### SUMMARY

This disclosure provides a sensing method for sensing an object in a sample solution based on a frequency change corresponding to a mass of the object adhered to the electrode, using a piezoelectric resonator including a piezoelectric piece with an electrode with an adsorbing layer to capture the object, and oscillating the piezoelectric resonator in contact with a liquid by an oscillator circuit. The sensing method includes: supplying the sample solution to the adsorbing layer; subsequently supplying a first liquid to the adsorbing layer, the first liquid including a first sensitizer to bind with the object; subsequently discharging the first liquid from the adsorbing layer; subsequently supplying a second liquid to the adsorbing layer, the second liquid including a second sensitizer, the second sensitizer reacting to the first sensitizer to generate an insoluble material; obtaining a first frequency signal corresponding to an oscillation frequency of the oscillator circuit, the oscillation frequency being obtained by oscillating the piezoelectric resonator after the first liquid is supplied to the adsorbing layer and before the second liquid is supplied to the adsorbing layer; and obtaining a second frequency signal corresponding to an oscillation frequency of the oscillator circuit, the oscillation frequency being obtained by oscillating the piezoelectric resonator after the second liquid is supplied to the adsorbing layer.

### BRIEF DESCRIPTION OF THE DRAWINGS

The foregoing and additional features and characteristics of this disclosure will become more apparent from the following detailed description considered with reference to the accompanying drawings, wherein:

FIG. 1 is a vertical cross-sectional view illustrating an exemplary sensing device that performs a sensing method according to this disclosure;

FIG. 2 is an exploded perspective view illustrating an exemplary sensor unit;

FIG. 3A and FIG. 3B are plan views illustrating an exemplary crystal resonator employed in the sensor unit;

FIG. 4 is a schematic diagram illustrating a circuit configuration in the sensing device;

FIG. 5 is a process view illustrating the sensing method according to the disclosure performed using the sensing device;

FIG. 6A and FIG. 6B are views of the process partially illustrating the sensing method;

FIG. 7A and FIG. 7B are views of the process partially illustrating the sensing method;

FIG. 8 is a flowchart illustrating the sensing method; and

FIG. 9 is a vertical cross-sectional view illustrating another exemplary sensing device that performs the sensing method according to this disclosure.

### DETAILED DESCRIPTION

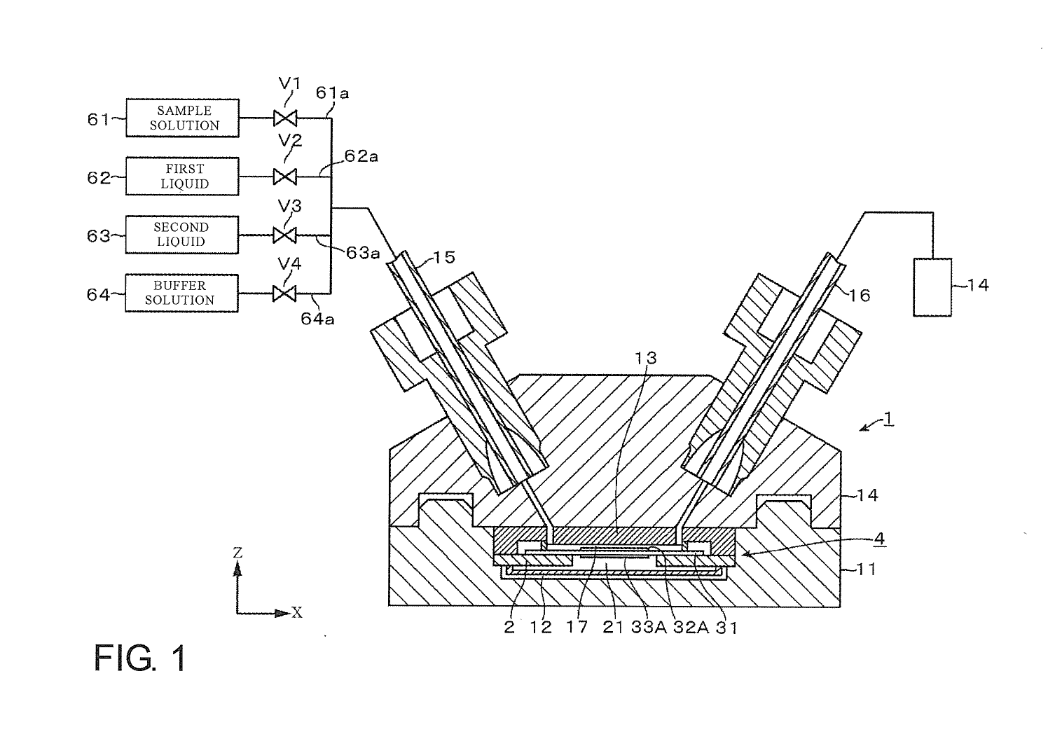

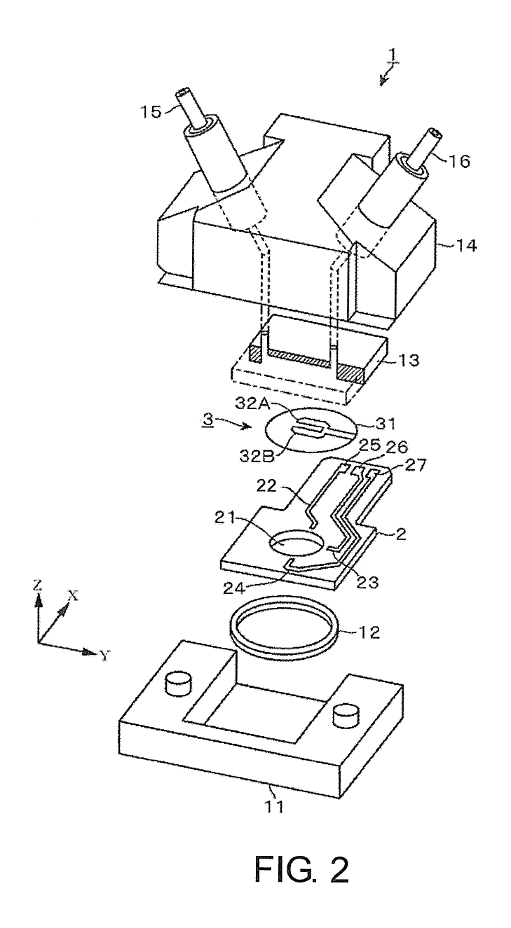

A description will be given of an exemplary sensing device that performs a sensing method according to this disclosure by referring to FIG. 1 to FIG. 4. This sensing device includes a quartz sensor, which is a sensing sensor, housed in a sensor unit 1. For example, the sensor unit 1, as shown in FIG. 1 and FIG. 2, is constituted by laminating a support body 11, a sealing member 12, a wiring board 2, a crystal resonator 3, which is a piezoelectric resonator, a channel forming member 13, and an upper cover 14 in this order from the lower side.

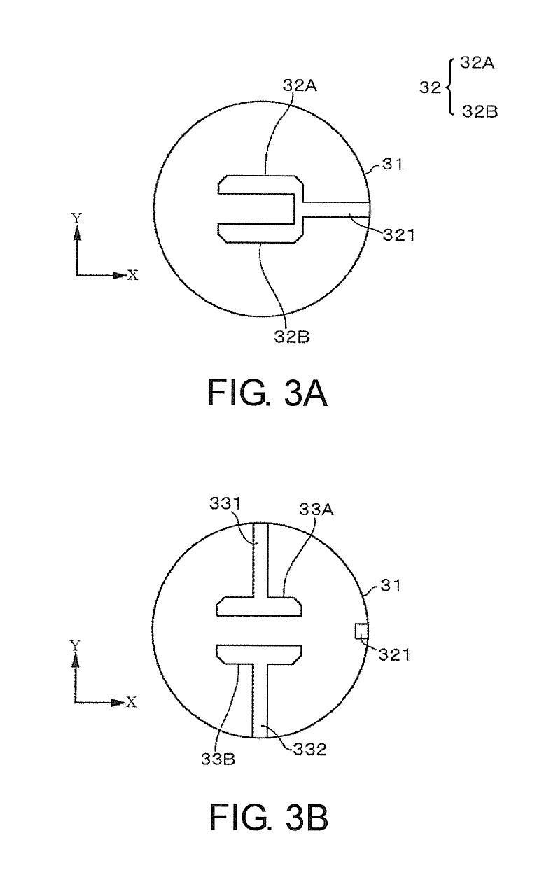

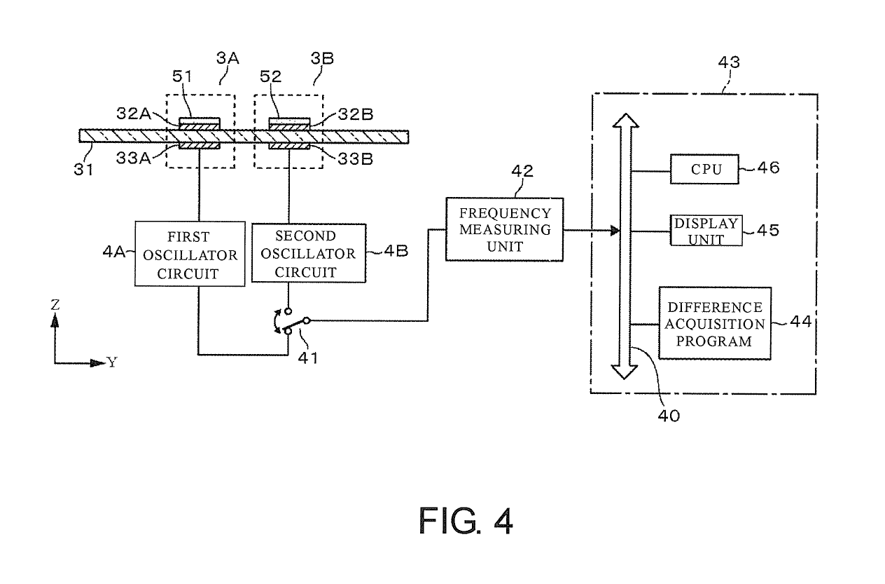

A quartz sensor 4 is formed by disposing the crystal resonator 3 on the wiring board 2. This crystal resonator 3, as shown in FIG. 2 and FIG. 3A and FIG. 3B, for example, includes excitation electrodes, which are made of gold (Au) or similar material, on the respective front surface side and back surface side of a discoid crystal wafer 31. The crystal wafer 31 is an AT-cut piezoelectric piece. In this example, as shown in FIG. 3A and FIG. 3B, the crystal wafer 31 includes a first excitation electrode 33A and a second excitation electrode 33B on the back surface side such that the first excitation electrode 33A and the second excitation electrode 33B are separated from one another. The crystal wafer 31 includes a common excitation electrode (a common electrode) 32 on the front surface side. The common electrode 32 includes a first excitation electrode 32A and a second excitation electrode 32B corresponding to the excitation electrodes 33A and 33B. Accordingly, as shown in FIG. 4, the first excitation electrode 33A and the first excitation electrode 32A form a first vibration region 3A. The second excitation electrode 33B and the second excitation electrode 32B form a second vibration region 3B.

The first excitation electrode 33A and the second excitation electrode 33B on the back surface side electrically connect to respective conductive paths 22 and 24 via extraction electrodes 331 and 332 as shown in FIG. 2. The conductive paths 22 and 24 are extended to the wiring board 2 when the quartz sensor 4 is mounted to the sensor unit 1. Additionally, the common electrode 32, which is formed on the front surface side and includes the first excitation electrode 32A and the second excitation electrode 32B, electrically connects to a conductive path 23 via an extraction electrode 321 formed to wrap around to the back surface side. The conductive path 23 is formed on the wiring board 2 when the quartz sensor 4 is mounted to the sensor unit 1. The wiring board 2 includes connecting terminals 25 to 27 formed on the end portion region. The connecting terminals 25 to 27 connect to the respective conductive paths 22 to 24. Then, these conductive paths 22 and 24, as shown in FIG. 4, respectively connect to a first oscillator circuit 4A and a second oscillator circuit 4B. The common electrode 32 connects to the ground sides of the oscillator circuits 4A and 4B. Note that FIG. 3A illustrates the front surface side of the crystal resonator 3, and FIG. 3B illustrates the back surface side of the crystal resonator 3.

The first excitation electrode 32A includes a first adsorbing layer 51 on the surface as shown in FIG. 4. The first adsorbing layer 51 captures and adsorbs a sensing object. A description will be given of the first adsorbing layer 51 with an example where a sensing object X is an antigen made of CRP (C-reactive protein). For example, the first adsorbing layer 51 contains an antibody A, such as an anti-CRP antibody. The antibody A captures the sensing object X, for example, by reacting to the antigen, which is the sensing object X. On the other hand, a second adsorbing layer 52 is formed on the surface of the second excitation electrode 32B. This adsorbing layer 52 is constituted by an antibody B, which does not react to the sensing object X, such as an anti-rabbit IgG antibody. Here, the reaction is defined as an action like an antigen-antibody reaction where binding the object (the antigen) with the adsorbing film (the antibody) adds a mass corresponding to the object mass. In this example, the sensing object X binds with the first adsorbing layer 51. By doing so, excitation electrodes 32A and 33A which constitute a first vibration region 3A become a pair of reaction electrodes. The excitation electrodes 32B and 33B which constitute a second vibration region 3B become a pair of reference electrodes. Here, the second adsorbing layer 52 is disposed at the pair of reference electrodes such that the measurement environment may be similar to that of the pair of reaction electrodes. Furthermore, in the case where sulfur (S) is included in the sensing object, this constitution prevents a reaction between the electrode, which is made of such as gold, and sulfur.

The crystal resonator 3 is mounted so as to cover a through hole 21 formed at the wiring board 2 as shown in FIG. 1 and FIG. 2. The quartz sensor 4 is mounted to the sensor unit 1 as shown in FIG. 2 with the respective front surface side and back surface side being pressed by the channel forming member 13 and the sealing member 12. The channel forming member 13 is made of an elastic body while the sealing member 12 is made of a ring-shaped elastic body. In FIG. 1 and FIG. 2, reference numeral 15 denotes a liquid supply pipe, and reference numeral 16 denotes a liquid discharge pipe. A liquid supply pipe 15 and a liquid discharge pipe 16 are constituted such that a liquid supplied via the liquid supply pipe 15 passes through a liquid supply area 17, which is a channel between the channel forming member 13 and the crystal resonator 3, and is discharged from the liquid discharge pipe 16.

Additionally, the liquid supply pipe 15, for example, connects to a supply source 61 for a sample solution, a supply source 62 for a first liquid, a supply source 63 for a second liquid, and a supply source 64 for a buffer solution via respective supply passages 61a, 62a, 63a, and 64a, which include valves V1 to V4 as shown in FIG. 1. The first liquid is defined as liquid that includes a first sensitizer 71. The first sensitizer 71 is defined as a substance that binds with the sensing object X, reacts to a second sensitizer 81, which will be described below, and generates an insoluble material 82. In this example, the first sensitizer 71 includes an absorbing component 72 and a reaction component 73. The absorbing component 72 binds with the sensing object. The reaction component 73 binds with this absorbing component 72, reacts to the second sensitizer 81, and generates the insoluble material 82. Specifically, for example, the absorbing component 72 of the first sensitizer 71 is made of a sensitizing antibody C of the sensing object X. For example, in the case where the sensing object X is made of a material that reacts to a site different from a site where the antibody A reacts to (binds with) the sensing object X, for example, CRP, an anti-CRP antibody or similar, which is different from the antibody A, is employed as this sensitizing antibody C. However, insofar as a reaction is confirmed, a material same as that of the antibody A may be employed as the sensitizing antibody C.

Additionally, as the reaction component 73 of the first sensitizer 71, for example, an alkaline phosphatase (ALP) is employed. This ALP is an enzyme that hydrolyzes a phosphoric acid ester compound under an alkalinity condition with a molecular weight of approximately 80000 to 100000. For example, ALP and the sensitizing antibody C are preliminarily reacted by amine coupling to preliminary generate the first sensitizer 71 where ALP is added to the sensitizing antibody C. Then, this first sensitizer 71 is obtained by purified gel filtration and dialysis to obtain a first liquid.

The second liquid includes the second sensitizer 81 that reacts to the reaction component 73 of the first sensitizer 71 and generates the insoluble material 82. In the case where the reaction component 73 is ALP, the second sensitizer 81 employs, for example, a mixture of BCIP (5-bromo-4-chloro-3-indolyl-phosphate) and NBT (nitroblue tetrazolium chloride), which are substrates of ALP. The second liquid is a solution containing a mixture of BCIP and NBT. Further, the buffer solution contains liquid that does not react to the sample solution, the first liquid, and the second liquid, for example, phosphate buffer.

When ALP, a reaction component 73 of the first sensitizer 71, is reacted with BCIP/NBT, which is the second sensitizer 81, ALP oxidizes BCIP and in the process NBT is oxidized, and yields NBT formazan, which is the insoluble material 82. This insoluble material 82 is a substance that does not dissolve into the sample solution, the first liquid, the second liquid, and the buffer solution, which are liquid supplied to the crystal resonator 3. The sample solution, first liquid, second liquid, and buffer solution are, for example, accumulated in a syringe pump or similar member and supplied to the liquid supply area 17 of the sensor unit 1 by a predetermined flow rate via the respective supply passages 61a to 64a and the liquid supply pipe 15. Additionally, a drain portion 65 is disposed at the downstream side of the liquid discharge pipe 16.

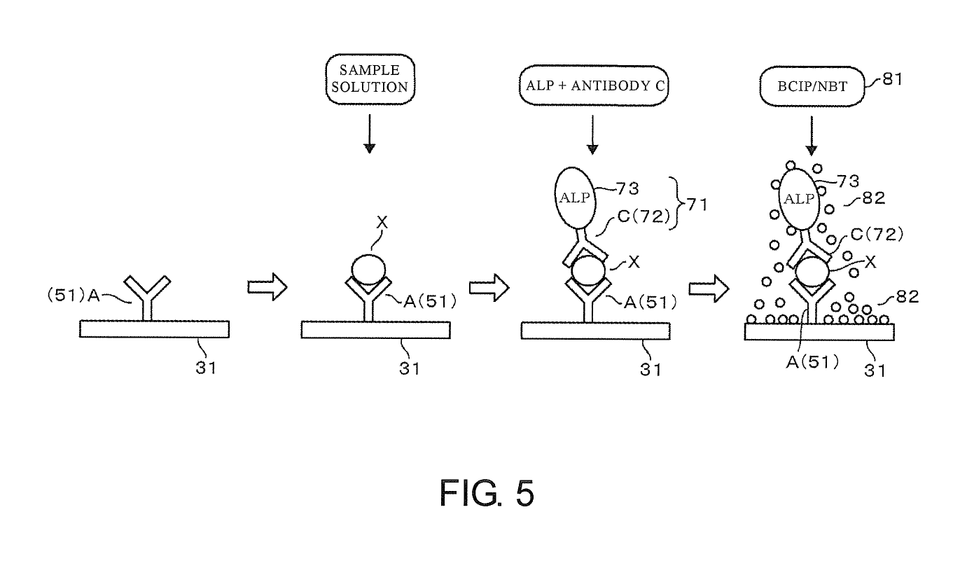

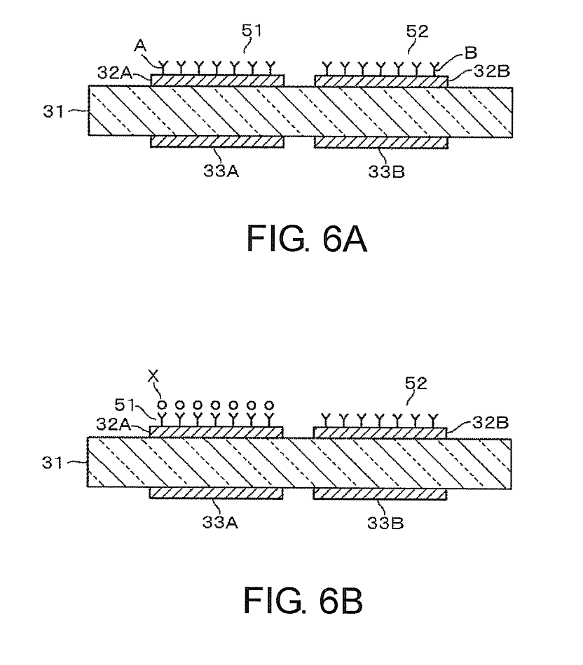

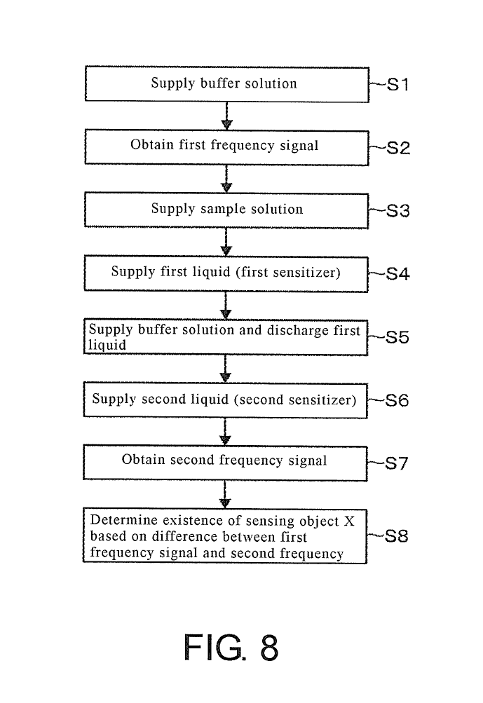

Returning to an explanation of the quartz sensor 4, as shown in FIG. 4, the first oscillator circuit 4A oscillates the first vibration region 3A while the second oscillator circuit 4B oscillates the second vibration region 3B. The oscillation outputs (the frequency signals) of the first oscillator circuit 4A and the second oscillator circuit 4B are configured to be alternately received to a frequency measuring unit 42 with a switch 41. This frequency measuring unit 42 is, for example, configured where a frequency is detected by a method using a frequency counter, a method by obtaining a rotational vector speed as disclosed in Japanese Unexamined Patent Application Publication No. 2006-258787, or similar method. The oscillation frequencies at the respective vibration regions 3A and 3B obtained at this frequency measuring unit 42 is sent to a data processor 43. For example, the respective oscillation frequencies are compared (the difference is calculated), for example, by a difference acquisition program 44, which is an operator, and, for example, the result is displayed at a display unit 45. In FIG. 4, reference numeral 46 denotes a CPU, and reference numeral 40 denotes a bus. Next, a description will be given of a sensing method according to this disclosure performed using the above-described sensing device in the case where the existence of the sensing object X is detected with reference to FIG. 5 to FIG. 8. First, in the crystal resonator 3 (referring to FIG. 2 also), as shown in FIG. 5 and FIG. 6A, the antibody A is secured on the surface of the first excitation electrode 32A to form the first adsorbing layer 51 while the antibody B is secured on the surface of the second excitation electrode 32B to form the second adsorbing layer 52. Next, this crystal resonator 3 is housed airtight in the sensor unit 1 and air-tightly integrated as shown in FIG. 2. The vibration regions 3A and 3B electrically connect to the respective oscillator circuits 4A and 4B via the connecting terminals 25 to 27 formed at the wiring board 2.

Subsequently, the valve V4 is opened, and the buffer solution is supplied to the sensor unit 1 at a predetermined flow rate via a supply passage 64a and the liquid supply pipe 15 (Step S1). The buffer solution passes through the liquid supply area 17 in the sensor unit 1, then, the atmosphere in the liquid supply area 17 changes from a gas phase to a liquid phase. Then, the crystal resonator 3 (the vibration regions 3A and 3B) is oscillated, for example, at a frequency of 9 MHz, by the respective oscillator circuits 4A and 4B. The frequency measuring unit 42 starts measuring the respective oscillation frequencies of the vibration regions 3A and 3B, thus the oscillation frequencies of the respective oscillator circuits 4A and 4B are obtained (Step S2). The oscillation frequency of the vibration region 3A obtained at this time corresponds to a first frequency signal. Note that the oscillation frequency measurement may be started before the buffer solution is supplied in the sensor unit 1.

After the buffer solution is supplied to fill the liquid supply area 17, the valve V4 is closed, and supply of the buffer solution is stopped. Then, the valve V1 is opened, and the sample solution is supplied to the sensor unit 1 at a predetermined flow rate via a supply passage 61a and the liquid supply pipe 15 (Step S3). Accordingly, the sample solution passes through the liquid supply area 17 in the sensor unit 1. In the case where the sensing object X is included in the sample solution, as shown in FIG. 5 and FIG. 6B, the sensing object X rapidly adsorbs (binds with) the first adsorbing layer 51 by an antigen-antibody reaction. On the other hand, since the sensing object X does not react to the antibody B, the sensing object X does not adsorb the second adsorbing layer 52.

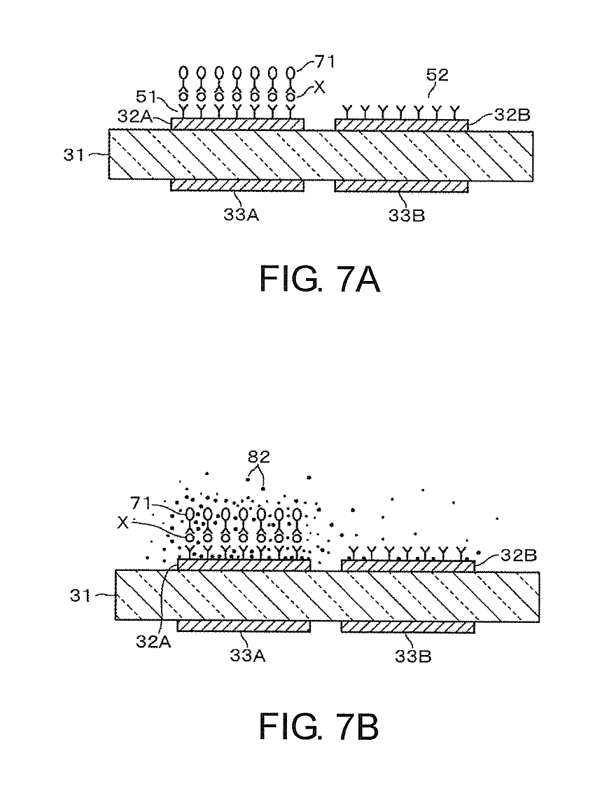

Thus, after the sample solution is supplied to the sensor unit 1 for a period that the first adsorbing layer 51 and the sensing object X react sufficiently, the valve V1 is closed to stop supplying the sample solution, and the valve V2 is opened to start supplying the first liquid (Step S4). In view of this, the first liquid passes through the liquid supply area 17 in the sensor unit 1. Accordingly, as shown in FIG. 5 and FIG. 7A, the absorbing component 72 (a sensitizing antibody C) of the first sensitizer 71 in the first liquid binds to the sensing object X captured on the first adsorbing layer 51 by the antigen-antibody reaction. On the other hand, since the sensing object X is not adsorbed on the second adsorbing layer 52, the absorbing component 72 passes through the liquid supply area 17 without adsorbing to the second adsorbing layer 52. After the first liquid is supplied to the sensor unit 1 for a period that the sensing object X and the absorbing component of the first sensitizer 71 react sufficiently, the valve V2 is closed to stop supplying the first liquid, and the valve V4 is opened to start supplying the buffer solution (Step S5). Since the buffer solution passes through the liquid supply area 17, the first liquid in the liquid supply area 17, which is on the excitation electrodes 32A and 32B, is discharged.

Thus, after the first liquid in the liquid supply area 17 is replaced by the buffer solution, the valve V4 is closed to stop supplying the buffer solution, and the valve V3 is opened to start supplying the second liquid (Step S6). In view of this, the second liquid passes through the liquid supply area 17. As described above, BCIP/NBT, which is the second sensitizer 81, reacts rapidly with ALP, which is the reaction component 73 of the first sensitizer 71, to generate the insoluble material 82. As shown in FIG. 5 and FIG. 7B, the insoluble material 82 adheres not only to around the peripheral area of ALP bound to the sensing object X but also to around the peripheral areas of the sensitizing antibody C and the sensing object X. Also, the insoluble material 82 precipitates on the first excitation electrode 32A. On the other hand, since ALP does not exist on the second excitation electrode 32B, even if the second liquid is supplied, the second liquid does not react to BCIP/NBT, and therefore the insoluble material 82 is not generated. FIG. 7B illustrates a state where the insoluble material 82 generated at the first excitation electrode 32A side moves to the second excitation electrode 32B side along a flow of liquid formed in the liquid supply area 17 by flow of the second liquid. Here, the buffer solution is passed through after the first liquid is passed through and before the second liquid is passed through. This is because the reaction of ALP in the first liquid and the reaction of BCIP/NBT in the second liquid quickly progress; therefore, a buffer solution is used to inhibit these reactions, which occur in the supply passage and the liquid supply pipe 15 through which the first liquid and the second liquid pass.

Thus, in the case where the sensing object X is included in the sample solution, the sensing object X is captured on the first adsorbing layer 51 at the first excitation electrode 32A side by the antigen-antibody reaction. Then, the absorbing component 72 of the first sensitizer 71 binds with the sensing object X captured on the first adsorbing layer 51 by the antigen-antibody reaction. Furthermore, reaction of the reaction component 73 of the first sensitizer 71, which is bound with the sensing object X, to the second sensitizer 81 on the first adsorbing layer 51 generates the insoluble material 82. Then, the insoluble material 82 precipitates on the first excitation electrode 32A.

The first sensitizer 71 employs ALP as the reaction component 73. Since this ALP has a large molecular weight of 80000 to 100000, simply binding the first sensitizer 71 with the sensing object X achieves an effect of adding mass. Reaction between ALP in the first sensitizer 71 and BCIP/NBT, which is the second sensitizer 81, reacts rapidly. Accordingly, a large amount of the insoluble material 82 is generated. This insoluble material 82, as described above, adheres to ALP and the sensing object X, and the sensitizing antibody C and the first adsorbing layer 51 by intermolecular force. In view of this, even if a flow of liquid by the second liquid is formed on the surface of the first excitation electrode 32A (the first adsorbing layer 51), the insoluble material 82 remains on the surface of the first excitation electrode 32A. Therefore, a substantially large mass is added to the first excitation electrode 32A.

Therefore, at the first vibration region 3A, the effect of the additional mass, which corresponds to not only the mass of the captured sensing object X, but also the mass of the first sensitizer 71 bound to the sensing object X, and the mass of the insoluble material 82 adhered to the first excitation electrode 32A side, reduces the oscillation frequency. After supplying the second liquid, the oscillation frequencies of the respective oscillator circuits 4A and 4B of these vibration regions 3A and 3B are obtained (Step S7). The oscillation frequency of the vibration region 3A obtained at this time corresponds to a second frequency signal. Then, subtraction is performed between the second frequency signal and the first frequency signal obtained before supplying the second liquid. The existence of the sensing object X is determined based on this subtraction (Step S8). The second frequency signal is obtained at the timing, for example, after a lapse of a period in which a sufficient reaction has occurred between the reaction component 73 of the first sensitizer 71 and the second sensitizer 81 after supply of the second liquid to the first excitation electrode 32A (the first adsorbing layer 51) begins. Specifically, for example, the timing is after a lapse of a period of 1200 seconds from when the second liquid is supplied to the sensor unit 1.

In the above-described example, the oscillation frequencies of respective vibration regions 3A and 3B are obtained at the timing of obtaining the first frequency signal, and subtraction of both is performed (difference data before supplying the second liquid). Additionally, the oscillation frequencies of respective vibration regions 3A and 3B are obtained at the timing of obtaining the second frequency signal, and a subtraction of both is performed (difference data after supplying the second liquid). Thus, subtracting the difference data obtained before supplying the first liquid from the difference data after supplying the second liquid calculates the frequency data corresponding to the mass of the sensing object X. Based on this data, the existence of the sensing object X is determined. This determination is performed as follows. For example, the data processor 43 compares the frequency data with a preset threshold value. If the frequency data is equal to or more than the threshold value, the sensing object X is determined as “present” while if the frequency data is less than the threshold value, the sensing object X is determined as “absent”. The determination result and the frequency data are, for example, displayed on the display unit 45. In this example, the oscillation frequency of the second vibration region 3B is caused by a disturbance such as a temperature change, viscosity of the solution itself, or adhesion of a substance other than the object. A frequency difference due to the absorption of the object can be obtained by subtracting the oscillation frequency of the second vibration region 3B from the oscillation frequency of the first vibration region 3A with a variation amount of the frequency due to disturbance being compensated. In view of this, a high accuracy measurement regarding existence of the sensing object X is achieved.

According to the above-described embodiment, as described above, when the sensing object X exists in the sample solution, an effect of adding mass corresponding to not only the mass of the captured sensing object X, but also the mass of the first sensitizer 71 bound to the sensing object X, and the mass of the insoluble material 82 precipitates at the first excitation electrode 32A side is expected. Accordingly, even if there is only a trace amount of the sensing object X, a change in frequency is amplified by the amount corresponding to the mass of the first sensitizer 71 and the mass of the insoluble material 82. This allows sensing the sensing object X with excellent sensitivity. Further, the first liquid including the first sensitizer 71 may be supplied to the first adsorbing layer 51, the first liquid may be discharged, and then the second liquid including the second sensitizer 81 may be supplied. This allows amplifying the change in frequency with a simple method. Moreover, only the absorbing component 72 and the reaction component 73, which constitute the first sensitizer 71, and the second sensitizer 81 are employed as agents. A small number of agents are employed. Since the first sensitizer 71 is the only preliminarily prepared agent, the preparation work is simple.

Further, the absorbing component 72 of the first sensitizer 71 is employed as the antibody to the sensing object X (the antigen), ALP, which is an enzyme, is employed as the reaction component 73, and BCIP/NBT, which is the substrate of ALP, is employed as the second sensitizer 81. This facilitates binding the first sensitizer 71 to the sensing object X and a reaction between the first sensitizer 71 and the second sensitizer 81. Accordingly, even if the sample solution, the first liquid, and the second liquid are supplied through the surface of the first adsorbing layer 51, the above-described reaction progresses sufficiently. Therefore, flowing through the sample solution, the first liquid, and the second liquid at a predetermined period and at a predetermined flow rate can reliably ensure an amplification action of a frequency. This reduces deterioration of throughput upon obtaining the amplification action.

Additionally, in the above-described example, the liquid is supplied through the sensor unit 1. After supplying the first liquid and before supplying the second liquid, the buffer solution is supplied such that the buffer solution passes through the surface of the first adsorbing layer 51 and discharges the first liquid from the surface of the first adsorbing layer 51. This facilitates the discharge operation.

Furthermore, the insoluble material 82 has a small molecular weight, for example, about 500. Passing the second liquid through the surface of the first adsorbing layer 51 allows the insoluble material 82 that does not precipitate on the first excitation electrode 32A to be discharged from the liquid supply area 17 along the flow of liquid. Therefore, a situation where the insoluble material 82 covers the flow path of the sensor unit 1 and impedes the second liquid from passing through, which causes the insoluble material 82 to precipitate on the excitation electrode 32B (the second adsorbing layer 52) side, is inhibited. Thus, stable measurement is achieved.

Subsequently, a description will be given of another example of the first sensitizer 71 and the second sensitizer 81 with reference to Table 1. As shown in Table 1, in the case where the reaction component 73 of the first sensitizer 71 is ALP, naphthol AS-BI phosphoric acid (Fast Red) can be employed as the second sensitizer 81. In this case, the insoluble material 82 made of azo dye is produced by the reaction between ALP and Fast Red.

Horseradish peroxidase (HRP) may be employed as the reaction component 73 of the first sensitizer 71. Any of Diamino benzidine (DAB), 3,3′,5,5′-Tetramethylbenzidine (TMB), and 3-amino-9-ethylcarbazole (AEC) may be employed as the second sensitizer 81. HRP is an enzyme that decomposes a peroxide structure, which has a molecular weight of approximately 40,000, into hydroxyl groups by oxidative cleavage. DAB, TMB, and AEC are substrates of HRP, respectively.

In this case, binding the sensitizing antibody C and HRP by amine coupling constitutes the first sensitizer 71. The first liquid is obtained by purifying this first sensitizer 71 by gel filtration or dialysis. The second liquid employs any of DAB, TMB, and AEC alone, which are the second sensitizer 81. In the case where the second sensitizer 81 is DAB, reaction of HRP and DAB generates oxidized DAB, which is the insoluble material 82. In the case where the second sensitizer 81 is TMB, reaction of HRP and TMB generates oxidized TMB, which is the insoluble material 82. Additionally, in the case where the second sensitizer 81 is AEC, reaction of HRP and AEC generates oxidized AEC, which is the insoluble material 82.

TABLE 1

| Reaction component of | | |
|---|---|---|
| first sensitizer | Second sensitizer | Insoluble material |
| ALP | BCIP/NBT | NBT formazan |
| ALP | Fast Red | Azo dye |
| HRP | DAB | Oxidized DAB |
| HRP | TMB | Oxidized TMB |
| HRP | AEC | Oxidized AEC |

In the description above, it is preferred that ALP and the sensitizing antibody C or HRP and the sensitizing antibody C be preliminarily bound. However, the reaction component 73 may be supplied after the absorbing component 72 is bound with the sensing object X by the antigen-antibody reaction. Thus, the process where the absorbing component 72 of the first sensitizer 71 is supplied to the adsorbing layer 51 and then the reaction component 73 is supplied to the adsorbing layer 51 is included in a process where the first liquid including the first sensitizer 71 is supplied to the adsorbing layer 51.

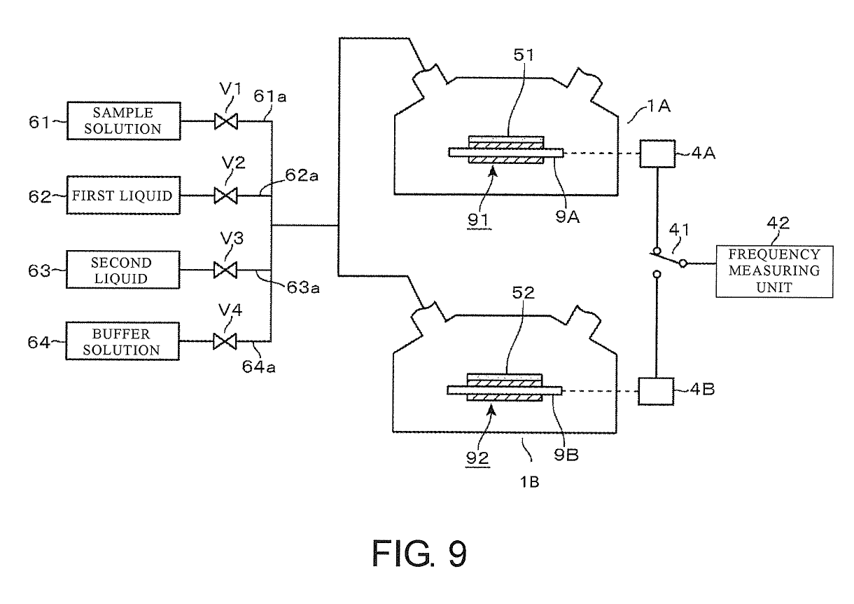

Additionally, the sensing device that performs the sensing method according to this disclosure may be configured as shown in FIG. 9. In this example, a crystal resonator 9A with a pair of reaction electrodes 91 and a crystal resonator 9B with a pair of reference electrodes 92 are prepared. One sensor unit 1A includes the crystal resonator 9A with the pair of reaction electrodes 91A while the other sensor unit 1B includes the crystal resonator 9B with the pair of reference electrodes 91B. The first adsorbing layer 51 is formed on the pair of reaction electrodes 91 while the second adsorbing layer 52 is formed on the pair of reference electrodes 92. The sample solution, the first liquid, the second liquid, and the buffer solution are supplied to the sensor units 1A and 1B, respectively via the supply passages 61a to 64a. For example, the sample solution, the first liquid, the second liquid, and the buffer solution are supplied to the sensor unit 1A and the sensor unit 1B at the same timing. The first oscillator circuit 4A oscillates the crystal resonator 9A while the second oscillator circuit 4B oscillates the crystal resonator 9B. The oscillation outputs (the frequency signals) of the first oscillator circuit 4A and the second oscillator circuit 4B are alternately retrieved to the frequency measuring unit 42 using the switch 41, respectively. This frequency measuring unit 42 is configured so as to obtain the difference data of frequencies by the above-described method. In this example, the pair of reaction electrodes 91 and the pair of reference electrodes 92 are disposed at the respective different sensor units 1A and 1B. This eliminates the possibility of moving the insoluble material 82 generated at the pair of reaction electrodes 91 side to the pair of reference electrodes 92 side. In view of this, a more highly accurate measurement is achieved.

In the description above, it is apparent from the embodiment described below, the amount of change in the oscillation frequency of the first vibration region 3A after supplying the second liquid is substantially large. Accordingly, when performing the qualitative analysis, which determines existence of the sensing object X, the existence may be determined based on the difference between the oscillation frequency (the first frequency signal) and the oscillation frequency (the second frequency signal). The oscillation frequency (the first frequency signal) is obtained after the liquid is supplied to and before the second liquid is supplied to the adsorbing layer 51. The oscillation frequency (the second frequency signal) is obtained after the second liquid is supplied to the adsorbing layer 51. Therefore, insofar as after the buffer solution is supplied to the adsorbing layer 51 and before the second liquid is supplied, the existence of the sensing object X can be determined by performing subtraction between the oscillation frequency of the vibration region 3A after supplying the second liquid and the oscillation frequency of the vibration region 3A at any time point. Additionally, supplying the buffer solution before supplying the sample solution is not necessary. The gas phase in the liquid supply area 17 may be replaced by a liquid phase by supplying the sample solution to the sensor unit 1.

In the description above, the sensing method according to this disclosure is also applicable to the quantitative analysis of the sensing object in the sample. A description will be given with the sensor unit 1 illustrated in FIG. 1 as an example. For example, the buffer solution is supplied to the sensor unit 1. Before the sample solution is supplied, the oscillation frequency (the first frequency signal) is obtained by oscillating the crystal resonator 3. The second liquid is supplied to the sensor unit 1, and the oscillation frequency (the second frequency signal) is obtained by oscillating the crystal resonator 3. Thus, for example, after the second liquid is supplied, a difference between the oscillation frequencies of the respective vibration regions 3A and 3B are obtained. From this difference, a difference between the oscillation frequencies of the respective vibration regions 3A and 3B obtained after supplying the buffer solution and before supplying the sample solution is subtracted. Frequency data corresponding to the mass of the sensing object X is calculated. Then, based on a calibration curve indicating the correlation relationship between the frequency and the mass, which are preliminarily obtained, the mass of the sensing object X is obtained.

In this disclosure, for example, the first frequency signal, which is obtained after liquid is supplied to the adsorbing layer and before the second liquid is supplied to the adsorbing layer, and the second frequency signal, which is obtained after the second liquid is supplied to the adsorbing layer, are displayed on the display unit 45. Based on the difference between these frequency signals, the operator may determine the existence of the sensing object X and may determine quantity of the sensing object X. The first frequency signal data and the second frequency signal data obtained at predetermined time intervals from the start of the measurement of the oscillation frequency or at the preset timing may be displayed on the display unit 45. Additionally, data obtained from the start of measurement of the oscillation frequency may be continuously plotted to graph the data and may be displayed.

Furthermore, in the above-described example, the buffer solution, the sample solution, the first liquid, and the second liquid are supplied to pass through the surface of the adsorbing layer 51. The speed at which the liquids pass through and the supply period may be changed depending on the kind of liquid. For example, with the sample solution, to sufficiently advance the respective reactions of the first liquid and the second liquid, the speed at which the respective liquids pass through and the supply period may be optimized. Moreover, for example, an opening/closing valve may be disposed at the liquid discharge pipe 16. When the sample solution, the first liquid, and the second liquid are supplied, the opening/closing valve may be closed for a predetermined period, the first liquid or similar liquid may remain adjacent to the surface of the adsorbing layer, the respective reactions may be sufficiently advanced, then penetration of the liquid may be resumed.

Additionally, in this disclosure, the process of discharging the first liquid from the adsorbing layer needs to be performed after the first liquid is supplied to the adsorbing layer and before the second liquid is supplied to the adsorbing layer. If the second liquid is supplied while the first liquid exists on the surface of the adsorbing layer 51, even if the sensing object X is not captured to the adsorbing layer 51, the first sensitizer 71 in the first liquid reacts to the second sensitizer 81 in the second liquid, generating the insoluble material 82 and precipitating the insoluble material 82 on the adsorbing layer 51. As described above, the insoluble material adheres to the adsorbing layer 51 (the excitation electrode 32A) by intermolecular force. Accordingly, even if the second liquid is discharged from the adsorbing layer 51 after the insoluble material 82 is generated, the insoluble material 82 partially remains. There is a possibility that a high accuracy measurement cannot be performed.

However, the buffer solution, the sample solution, the first liquid, and the second liquid need not to be always supplied through the surface of the adsorbing layer 51. This is because discharging the first liquid from the adsorbing layer 51 after the first liquid is supplied to the adsorbing layer 51 and before the second liquid is supplied reduces the reaction between the first sensitizer 71 and the second sensitizer 81 when the sensing object is not included. Here, a process of discharging the first liquid from the adsorbing layer 51 may be performed by the following methods. The operator may remove the first liquid from the adsorbing layer 51. Alternately, as the above-described example, the first liquid may be replaced by the buffer solution. Further, the first liquid may be removed by a vacuum using a pump or similar member. To vacuum and remove the first liquid from the liquid supply area 17 in the above-described sensor unit 1, supplying the buffer solution after supplying the first liquid is not required. Furthermore, the valves V1 to V4 may be manually switched or may be operated automatically.

Furthermore, in this disclosure, as the reaction component 73 of the first sensitizer 71, ALP and HRP may be used in combination. In the case where the reaction component 73 of the first sensitizer 71 is ALP, as the second sensitizer 81, BCIP/NBT and Fast Red may be used in combination. In the case where the reaction component 73 of the first sensitizer 71 is HRP, as the second sensitizer 81, any or all of DAB, TMB, and AEC may be used in combination. In this disclosure, a crystal resonator other than an AT-cut crystal resonator may be used.

### Working Example

Using the sensing device shown in FIG. 1, as the sensing object X, the sample solution including CRP (the antigen) was passed through the sensor unit 1, and a change in the oscillation frequency was measured. At this time, the antibody “A” made of an anti-CRP antibody was formed on the surface of the first excitation electrode 32A as the first adsorbing layer 51. Meanwhile, the antibody B made of an anti-rabbit IgG antibody was formed on the surface of the second excitation electrode 32B as the second adsorbing layer 52. With the first sensitizer 71, the sensitizing antibody C made of the anti-CRP antibody different from the antibody A was used as the absorbing component 72 and ALP as the reaction component 73. Then, the buffer solution, the sample solution, the first liquid, the buffer solution, and the second liquid were supplied to the sensor unit 1 in this order at the flow rate of 5 μl/min for 600 seconds, respectively. The oscillation frequencies of when the sample solution was supplied, the first liquid was supplied, and the second liquid was supplied, were obtained, respectively. The time interval of obtaining the oscillation frequency was after 1200 seconds elapsed from the start of supply of each liquid to the sensor unit 1. Table 2 lists oscillation frequencies obtained at the respective timing after the sample solution is supplied to the sensor unit 1. This oscillation frequency indicates a difference between the oscillation frequency obtained at respective time intervals and the oscillation frequency obtained while the buffer solution was supplied.

TABLE 2

| | Supply of | | |
|---|---|---|---|
| | sample | Supply of | Supply of |
| | solution | first liquid | second liquid |
| Pair of reaction | 3.79 Hz | 8.84 Hz | 5726.61 Hz |
| electrodes | | | |
| Pair of reference | 5.51 Hz | 1.52 Hz | 139.56 Hz |
| electrodes | | | |

From this result, it was confirmed that oscillation frequency data after the second liquid was supplied differed largely between the pair of reaction electrodes and the pair of reference electrodes. By generating the insoluble material 82 by the reaction between the first sensitizer 71 and the second sensitizer 81, a significant effect can be obtained in the increase in mass, and a change in frequency is substantially amplified. Note that after supplying the second liquid, the change in frequency substantially increased also with the pair of reference electrodes. This probably occurred by the following situation. The insoluble material 82 generated at the first excitation electrode 32A side flowed to the second excitation electrode 32B along the flow of the second liquid in the liquid supply area 17, and precipitated on the excitation electrode 32B.

When the object is included in the sample solution, supplying the sample solution to the adsorbing layer formed at the electrode of the piezoelectric resonator captures the object on the adsorbing layer. Next, supplying the first liquid to the adsorbing layer binds the first sensitizer included in the first liquid with the object. Subsequently, supplying the second liquid to the adsorbing layer reacts the second sensitizer included in the second liquid to the first sensitizer, generates the insoluble material, and precipitates the insoluble material on the electrode. Thus, with a simple method of supplying the first liquid and the second liquid obtains mass increase corresponding to the mass of the first sensitizer and the insoluble material. A frequency change can be amplified corresponding to this mass increase.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A sensing method for sensing an object in a sample solution based on a frequency change corresponding to a mass of the object adhered to the electrode, using a piezoelectric resonator including a piezoelectric piece with an electrode with an adsorbing layer to capture the object, and oscillating the piezoelectric resonator in contact with a liquid by an oscillator circuit, the sensing method comprising:
supplying the sample solution to the adsorbing layer;
subsequently supplying a first liquid to the adsorbing layer, the first liquid including a first sensitizer to bind with the object;
subsequently discharging the first liquid from the adsorbing layer;
subsequently supplying a second liquid to the adsorbing layer, the second liquid including a second sensitizer, the second sensitizer reacting to the first sensitizer to generate an insoluble material;
obtaining a first frequency signal corresponding to an oscillation frequency of the oscillator circuit, the oscillation frequency being obtained by oscillating the piezoelectric resonator after the first liquid is supplied to the adsorbing layer and before the second liquid is supplied to the adsorbing layer; and
obtaining a second frequency signal corresponding to an oscillation frequency of the oscillator circuit, the oscillation frequency being obtained by oscillating the piezoelectric resonator after the second liquid is supplied to the adsorbing layer.

2. The sensing method according to claim 1, wherein
the sample solution, the first liquid, and the second liquid are supplied through a surface of the adsorbing layer.

3. The sensing method according to claim 1, wherein
the first sensitizer includes an absorbing component and a reaction component,
the absorbing component binding with the object,
the reaction component binding with the absorbing component, and the reaction component reacting to the second sensitizer to generate the insoluble material.

4. The sensing method according to claim 2, wherein
the first sensitizer includes an absorbing component and a reaction component,
the absorbing component binding with the object,
the reaction component binding with the absorbing component, and the reaction component reacting to the second sensitizer to generate the insoluble material.

5. The sensing method according to claim 3, wherein
the first sensitizer includes an absorbing component, the first sensitizer being an antibody of the object, and
the first sensitizer includes a reaction component, the reaction component containing at least one of alkaline phosphatase and horseradish peroxidase.

6. The sensing method according to claim 4, wherein
the first sensitizer includes an absorbing component, the first sensitizer being an antibody of the object, and
the first sensitizer includes a reaction component, the reaction component containing at least one of alkaline phosphatase and horseradish peroxidase.

7. The sensing method according to claim 5, wherein
the second sensitizer contains at least one of a mixture of 5-bromo-4-chloro-3-indolyl-phosphate and nitroblue tetrazolium chloride, and naphthol AS-BI phosphoric acid when the reaction component of the first sensitizer is alkaline phosphatase.

8. The sensing method according to claim 6, wherein
the second sensitizer contains at least one of a mixture of 5-bromo-4-chloro-3-indolyl-phosphate and nitroblue tetrazolium chloride, and naphthol AS-BI phosphoric acid when the reaction component of the first sensitizer is alkaline phosphatase.

9. The sensing method according to claim 5, wherein
the second sensitizer contains at least one of Diamino benzidine, 3,3′,5,5′-Tetramethylbenzidine, and 3-amino-9-ethylcarbazole when the reaction component of the first sensitizer is horseradish peroxidase.

10. The sensing method according to claim 6, wherein
the second sensitizer contains at least one of Diamino benzidine, 3,3′,5,5′-Tetramethylbenzidine, and 3-amino-9-ethylcarbazole when the reaction component of the first sensitizer is horseradish peroxidase.
